(19) United States
(12) Patent Application Publication
(10) Pub. No.: US 2006/0161462 A1
(43) Pub. Date: Jul. 20, 2006

(54) Method and apparatus for collecting inventory information for insurance purposes

(76) Inventor: Arvind Sharma, Menlo Park, CA (US)

Correspondence Address: RONALD CRAIG FISH;RONALD CRAIG FISH, A LAW CORPORATION, POST OFFICE BOX 820, LOS GATOS, CA, 95031, US

(21) Appl. No.: 11/039,128

(22) Filed: Jan. 18, 2005

(51) Int. Cl. G06Q 40/00

(52) U.S. Cl. 705/4

(57) ABSTRACT

A method and appartus for automatically gathering data about assets of a data center for use in assessing risks in writing insurance policies. The method uses collection servers coupled to the network or networks of the data center. The collection servers are informed of the IP address range and ping all addresses to find addresses at which active machines reside. Then a plurality of protocols are executed to send packets to the active IP addresses in accordance with a plurality of different protocols in an attempt to elicit meaningful responses. If a meaningful packet arrives back from a machine, the protocols try to decipher it to determine what protocols the machine understands. Once the protocol(s) the machine understands are known, packets are sent to invoke function calls of known APIs of that protcol to extract information about the machine. If more information is needed, login ID and passwords are obtained for the machines of interest, and the collection servers log into the machine of interest, and invoke function calls of the known APIs of the operating system of the machine to extract more data about the machine. The gathered data is analyzed and sent to the insurance company.

### BACKGROUND OF THE INVENTION

Large organizations and small organizations with data centers have collected in one place (the data center) a large number of server and client computers loaded with large number of software programs such as operating systems and application programs, printers, storage devices, networking equipment such as hubs and routers, and communication devices such as FAX machines, telephones etc. plus large amounts of data stored in files on storage devices and backup media. Frequently, these organizations want insurance on this equipment and data to protect the organization from losses of the equipment and/or data. Frequently, the organizations are concerned about physical loss of the equipment and data caused by fire, earthquake, flooding, theft, etc. These organizations are also concerned about costs of reconstructing lost data, or restoring data from off site backup locations. In addition, these organizations may be concerned about security breaches such as compromised data caused by hackers hacking into the network of the data center and accessing confidential files containing information valuable to identity thieves or for other nefarious purposes.

In the past, when such organizations attempted to secure insurance to cover one or more of these risks, there was a problem for the insurance companies in determining the type and number of assets present in the data center. The type and number of assets in the data center (including data) is important to the insurance company to prejudge the amount of a loss in case such a loss might occur given the type of coverages requested by the client. In addition, coverage for different risks puts different types of assets in issue. Coverage for various types of risks requires the drafting of different types of insurance policies, and an inventory of the assets likely to be affected by covered losses is important to an insurance company to attempt the prejudge their exposure in case a covered loss occurs. So it is important for an insurance company to do an assessment of the number and type of assets which would be involved if an event that a loss of the type covered by the policy were to occur.

The problem is that these data centers often have thousands of client computers, servers, operating systems, application programs, firewalls, storage devices, backup storage devices, data files, hubs, routers, etc. The insurance companies need to know many things about these assets. For example, the insurance companies need to know the age of the systems, batch levels, operating system versions, the application programs on the system, the linkage between the applications in terms of which applications are communicating with which other applications, etc. The insurance company also needs to know how many of each type asset are present in the data center, whether there are backup files for the data files, and whether there are backup machines and backup files and whether they are stored onsite or offsite. So there is a large problem in determining just exactly what a data center has.

In the prior art, the insurance companies would simply ask the data center IT personnel to determine the assets and prepare a list of what they have. If done manually, this is time consuming, costly and prone to errors. Often IT departments have lists that they keep, but the lists rapidly become out of data and it is a large problem to keep such lists current. So in the prior art, a combination of manual inventory and working with agent based programs has been used to gather data for the inventory. Agent based systems install a piece of agent code on each system from which information is to be gathered. That code allows queries to be sent to the machine from elsewhere. The agent then responds to the query by making a query to the operating system of the machine in which it is resident to gather the requested information and sends the information back to the querying machine. Examples of such agent based systems are: Microsoft SMS, HP Open View, IBM Tivoli and BMC Patrol. Examples of queries include: “What operating system is present on your machine? What version is the operating system? How much disk space and memory do you have? What application programs do you have installed?” The problem with this approach is that it requires creation and installation of a new agent program on every computer, hub, disk storage array, printer, FAX machine, gateway etc. in a data center to be inventoried. This re-invents the wheel since each of these machines already has an agent that can be queried in the form of the machine's operating system. The need to install a separate agent on each device, aside from the expense of creating and installing the agents, creates an administrative headache since the IT department must install agents on every new piece of equipment and re-install on every machine which has been re-formatted or had its hard disk replaced.

Another problem with these agent programs is that they cannot gather very much detail about devices other than servers such as voice-or-IP telephones, routers, printers, etc. The reason for this is that these agent programs only use one or two protocols such as SNMP to query the operating system of the device. If that is the only protocol and it is disabled, the agent does not get any information at all. Many more protocols are needed to gather a wealth of detailed information about all the different types of digital machines in a data center.

Another problem with agent based systems is that the agents must be installed on every machine in every data center of every client for which an insurance company is attempting to write a policy. Some, probably most, data centers will not have the agents already installed. Some data centers may have a mix of Microsoft SMS and IBM Tivoli agents installed. Some data centers may have machines run by operating systems which are no longer supported for which no agent programs exist, such as minicomputers by Digital Equipment Corporation (acquired by Compaq which was acquired by HP—result OS no longer supported). If the insurance company approaches these clients and tells them it wants to install agent programs on every machine in the data center, those clients are highly likely to have an adverse reaction. This is because of the possibility of trouble with the agent programs and the need to maintain them or possible conflicts between the agent programs and other applications on the machine. There is also the confusion caused by a mix of agent programs These clients do not want to have any further maintenance burdens than they already have, and prefer not to have any programs installed on their systems which were not installed by their IT department so that they can maintain control and management of their IT resources.

The operating system of a machine is responsible for keeping track of all the types of information that these prior art agent programs attempt to obtain. If it were possible to create a user account on the operating system and send queries to it using a large number of protocols acting through one or more published application programmatic interfaces, the expense and hassle of separate agent programs could be avoided and more detailed information could be gathered about non server type devices. That is what the need is which the invention described herein fills.

Insurance companies usually require relatively frequent updates to their lists so that they can maintain a relatively accurate and up to date picture of the risks they are insuring. Because of the magnitude and difficulty of the task, IT departments do not relish the process of gathering all this data for the insurance company to secure the initial insurance policy and having to repeat the process periodically according to the terms of the policy such as when the policy renews. There is also the danger that if the IT department gets the count wrong or fails to update the information the insurance with relying upon as the data center grows larger. If a loss event covered by the policy occurs, the insurance company will investigate and find that the number and type of assets destroyed or compromised is different than the number and type of assets reported by the IT department. This can lead to accusations of fraud against the organization in securing the insurance coverage and refusal by the insurance company to pay the claim.

Therefore, a need has arisen for a fast, accurate, automated way to gather information about what assets a data center to be insured has which can be used on an initial basis to secure an insurance policy and subsequently to easily, quickly and accurately update the asset list for purposes of renewal.

In the prior art, the assignee of the present invention has provided a system to automatically gather information about the assets an organization has. This prior art system is described in a U.S. patent application entitled APPARATUS AND METHOD TO AUTOMATICALLY COLLECT DATA REGARDING ASSETS OF A BUSINESS ENTITY, filed Apr. 18, 2002, Ser. No. 10/125,952 which is hereby incorporated by reference. This system can be used as is as part of the business method of the present invention. However, in the preferred embodiment, an improved version of this prior art system is used as part of the business method described and claimed herein.

### SUMMARY OF THE INVENTION

A method and appartus for automatically gathering data about assets of a data center for use in assessing risks in writing insurance policies is disclosed herein. The method uses collection servers coupled to the network or networks of the data center. The collection servers are informed of the IP address range and ping all addresses to find addresses at which active machines reside. Then a plurality of protocols are executed to send packets to the active IP addresses in accordance with a plurality of different protocols in an attempt to elicit meaningful responses which indicate what type of machine resides at that address and what operating system is controlling it and what protocols it understands. If a meaningful packet arrives back from a machine, the protocols try to decipher it to determine what protocols the machine understands. Once the protocol(s) the machine understands are known, packets are sent to invoke function calls of known APIs of that protocol to extract information about the machine such as its operating system, OS version and manufacturer, etc. If more information is needed, login ID and passwords are obtained for the machines of interest, and the collection servers log into the machine of interest, and invoke function calls of the known APIs of the operating system of the machine to extract more data about the machine. The gathered data is analyzed and sent to the insurance company.

The teachings of the invention in one embodiment contemplate an automated information gathering system which uses a collection server to log into a network in a data center under a user account established on a server for the purpose of collecting information about the computing devices in a data center. Instead of using agent programs that have to be specially installed on the computing devices in the data center, the invention use the operating system of any digital computing device as an agent and uses multiple different protocols to query the operating system's application programmatic interfaces to gather information about the device. Not every device in the data center has a user account established for it. For example, printers and routers do not support user accounts. However, they do have operating systems and application programmatic interfaces which can be queried to gather information about the device. As long as the printer or router is connected to the data center network and has an IP address, it can be queried by the system of the invention. The system of the invention first pings the IP address of each computing device detected on the data center's network and attempts to determine which type of operating system the device is executing. Once the operating system is determined, a set of scripts peculiar to that operating system are executed to invoke function calls of the Application Programmatic Interface (API or APIs) to request data about each computing device. The returned data is stored in the collection server.

SNMP, a prior art information gathering protocol, is usually used to determine the operating system. Sometimes, older legacy devices do not have SNMP capability or the SNMP protocol stack of a newer device is disabled. For example, information about a network router is desired, but the router has its SNMP protocol turned off. In such a case, the information gathering system according to the invention queries the File Transfer Protocol port or the http port, and parses the string that is returned to determine the type of operating system that is controlling the device. Then protocols or scripts (called fingerprints in the prior patent application) designed to query the APIs of whatever type operating system is found are used to gather further information about the device which may be of interest to an insurance company attempting to write appropriate coverage for a data center.

The advantage of this structure and method is that as new situations are encountered to gather data, new scripts or protocols can be written to control the collection server to collect data which cannot be collected by agent programs using standard collection protocols such as SNMP.

All that is necessary for this process to occur is the establishment of a user account in the data center of the client, discovery of the IP addresses of the network computing devices about which information is to be gathered and a suitable collection of scripts in the collection server. There is no need to install agent programs or maintain them. When an insurance company needs to renew its policy, the collection servers can be brought in again to the data center of interest and the user account used again to log into the network and perform the data collection protocols to gather the required data needed to update an insurance policy.

### BRIEF DESCRIPTION OF THE DRAWINGS

FIG. 1 is a block diagram of a typical data center network in which the teachings of the invention may be practiced.

FIG. 2 is a flow diagram of the process the insurance company carries out to gather sufficient information in an automated fashion to write an insurance policy.

### DETAILED DESCRIPTION OF THE PREFERRED AND ALTERNATIVE EMBODIMENTS

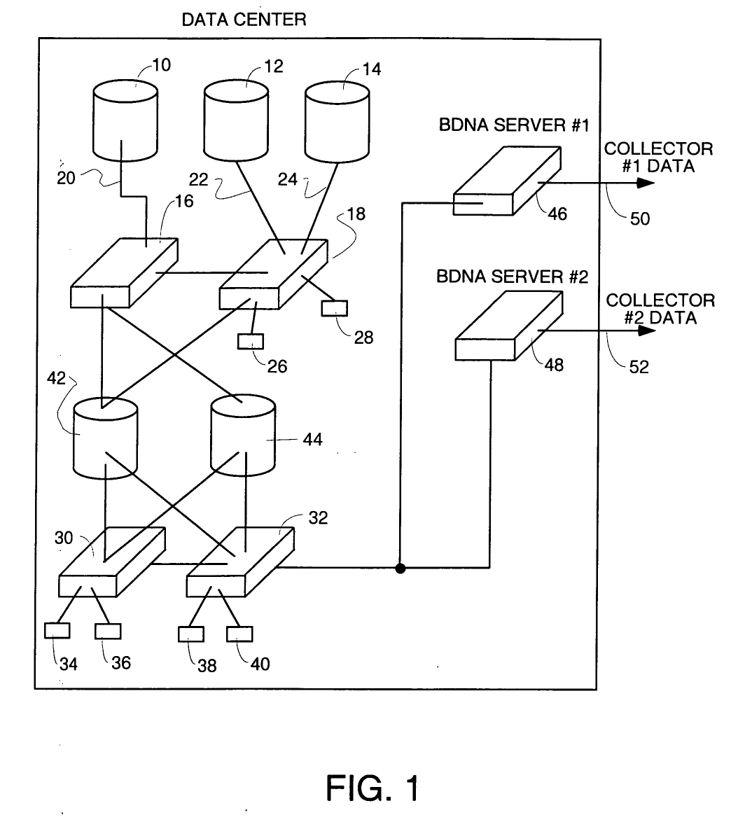

Referring to FIG. 1, there is shown a block diagram of a typical network setup in a data center where the teachings of the invention may be practiced. Typically, such data centers have one or more mass storage devices such as RAID arrays or disk drive arrays such as are shown at 10, 12 and 14. Typically, these mass storage devices store a plurality of databases and other files generated by servers 16 and 18 which are coupled to the mass storage devices via network connections such as 20, 22 and 24. The servers may have one primary server 18 coupled to two main storage devices 12 and 14 and a plurality of client computers or workstations 26 and 28. The primary server 18 may have a mirrored backup server 16 which stored mirrored copies of files on disk array 10 which match and backup the files stored on arrays 12 and 14. Other servers 30, 32 having client computers 34, 36, 38 and 40 may do other work and store other types of files on storage arrays 42 and 44. All the servers and client computer have operating systems and application programs of various versions and service packs. All sorts of information about a business entity including its leases, payables, physical assets, financial assets such as contracts, etc. may be of interest to an insurance company. A way to easily collect this information in a fast, accurate, automated fashion is desirable.

A pair of BDNA collection servers to perform this function of automated collection of data about the assets of the organization are shown at 46 and 48. These collection servers are programmed with one or more programs like those described in US patent application APPARATUS AND METHOD TO AUTOMATICALLY COLLECT DATA REGARDING ASSETS OF A BUSINESS ENTITY, filed Apr. 18, 2002, Ser. No. 10/125,952 or similar programs capable of controlling the collection servers to gather the necessary data.

Basically, the collection servers execute scripts of various types to gather the various types of information of interest. Each script contains all the necessary instructions to control the collection server to do whatever is necessary to collect the particular type of data the script is designed to collect. The scripts may involve sending an email to a particular manager requesting a report regarding the existence and/or number and/or terms of certain financial assets or liabilities or a protocol to log onto a particular one or more of the servers and instructions how to make calls to particular application programmatic interfaces of the operating system. These calls may be designed to extract such information as the type and version of the operating system, the number and type of application programs resident on the server and/or its client computers, the hardware version of the server, the number of CPUs in the server, the service pack information, the amount of available memory, the size of any internal bulk storage, the number and type of peripheral devices to which the server is connected, etc.

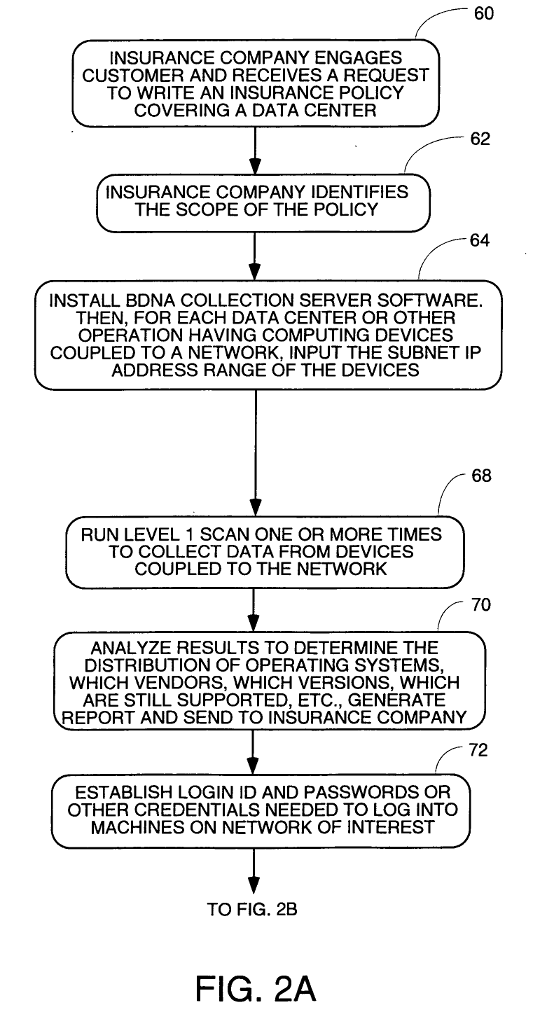

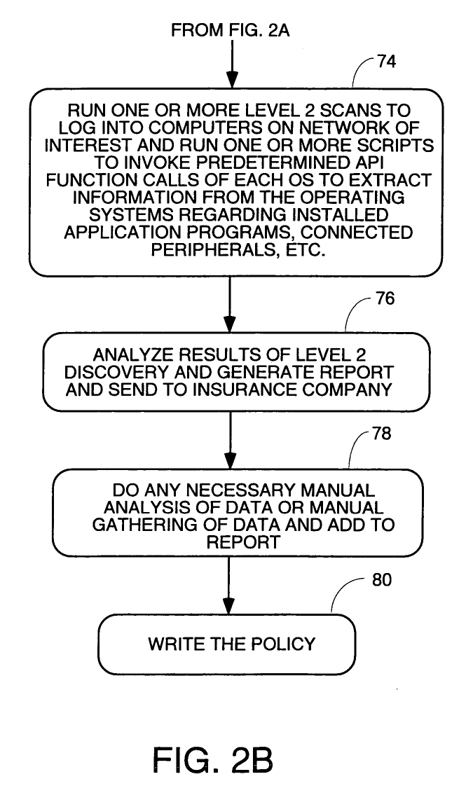

Referring to FIG. 2, there is shown a flow diagram for a process carried out by an insurance company to collect data about assets in a business organization for purposes of writing an insurance policy on some aspects of the operation of the company. Step 60 represents the process of the insurance company engaging a client and receiving a request to write an insurance policy for some aspect of the client's business. In step 62, the insurance company then identifies the scope of the intended policy to determine if it covers just a data center, an entire region of operations or the entire company and to identify the risks covered. This is a manual step and is known in the prior art as is tep 60.

Step 64 represents the process of installing the collection servers on every network of every data center to be covered by the insurance policy. If one or more networks are bridged together, it is only necessary to install a server on one of the networks so long as the server can send packets to all devices coupled to all the networks which are connected by bridges. In alternative embodiments, BDNA or other equivalent data collection software can be installed on servers which are already installed on the networks of the data centers to be covered so long as the servers have the appropriate operating system and other requirements of the data collection software. Step 64 also represents the process of obtaining the subnet IP addresses or address range for the networks of each data center or other network-based business operation to be covered by the policy. The IP address range is then input to the collection server(s). The IP address range is a key input to the collection servers 46 and 48 because the range defines the IP addresses which the collection servers will scan to find active devices coupled to the one or more networks in the data center and to which queries will be directed. Step 66 represents the process of installing a collection server on each network from which data is to be gathered in a data center to be covered by an insurance policy. This step can be accomplished by either installing the data collection software on a suitable server already connected to the network of the data center or by installing a new server on the network, the new server being programmed with the data collection software. The data collection software that needs to be installed is preferably the BDNA software offered commercially by BDNA Corporation of Mountain View, Calif. or the equivalent thereof.

Step 68 represents the process of the collection servers running a level 1 scan one or more times to collect data from devices coupled to the network. The level 1 scan involves first sending ping command packets to every IP address in said address range. Any active devices coupled to an IP address will send back a response packet. That response packet will be some kind of indication of what kind of device replied, but more work remains to be done to determine exactly what kind of device is coupled to the IP address, what its operating system is, its version, etc.

To determine the rest of the information, the collection servers execute about 150 protocols trying to communicate with each device at an IP address determined to be active. These protocols include SNMP, HTTP, FTP, SMTP, NMAP, etc. and result in packets according to the protocol being sent to each active IP address. SNMP, a prior art information gathering protocol, is usually used to determine the operating system. Sometimes, older legacy devices do not have SNMP capability or the SNMP protocol stack of a newer device is disabled. For example, information about a network router is desired, but the router has its SNMP protocol turned off. In such a case, the information gathering system according to the invention queries the File Transfer Protocol port or the http port, and parses the string that is returned to determine the type of operating system that is controlling the device. Then protocols or scripts (called fingerprints in the prior patent application) designed to query the APIs of whatever type operating system is found are used to gather further information about the device which may be of interest to an insurance company attempting to write appropriate coverage for a data center.

If the device understands one of these protocols, it will send back response packets which will make sense and tell the collection server which protocol to use for further communication. Once one or more protocols are discovered that each device at an active IP address understands, the collection servers will use that protocol to send packets to each machine to invoke function calls of known application programmatic interfaces for the protocols the machine understands. These function calls will solicit as much information as possible about the machine configuration in terms of hard disk presence or absence, hard disk capacity, state of the hard disk in terms of how much capacity it has left, the machine's manufaturer, the machine's serial number, its operating system, OS manufacturer and version, application programs installed, etc.

Multiple level 1 scans are preferred since at any particular time, some devices may be turned off or disconnected from the network for maintenance. In general, a level 1 scan involves doing a discovery process to determine which devices are on a network by running many protocols to collect data from the devices on the network to determine which operating systems they are running and to determine at least some of the applications which are present on computers in the network. This large number of protocols gives pretty good results in terms of the ability to recognize different types of machines coupled to the network. The level 1 scan determines what types of operating systems are running machines on the network, any other network equipment which is coupled to the network, whether there is IP telephony equipment coupled to the network, whether there is a storage area network coupled to the network, whether there is an NAS arrangement on the network, and which network services the network provides, and, by inference, whether certain application programs are present on computers in the network.

Step 70 represents the process of the insurance company analyzing the results of the level one scans to determine the distribution of operating systems, the distribution of IP addresses and to identify IP addresses at which resides equipment for which more detail is needed. Analysis of the results can be implemented by predefined reports which the collection servers can run or by filter templates which allow the collected data to be viewed through a filter so that only the data of interest is shown. The collected data or some report thereof can be hand delivered or sent electronically to the insurance company from the collection servers.

The insurance company may be interested in knowing which operating systems are active, which vendors supply that operating system, what version each operating system is, is that version supported by the vendor, are there known security vulnerabilities of that version and are there any dependencies. Various filter conditions can be applied. For example, the insurance company may apply filter conditions to run a report on the level 1 discovery results to determine only which operating system versions which are running in a data center which are no longer supported by the vendor. This affects the risk being insured against if downtime is covered by the policy because if an operating system which is no longer supported fails, substantially more time will be lost in trying to resolve the problem or upgrading to a supported version of the operating system and then having to upgrade all applications programmed on the server or its client which will not run on the new operating system.

The level 1 scan run by the collection servers just determines the operating systems and the versions. However, the collection servers, if they are running the BDNA software supplied by the assignee of the present invention, have overlays which can be compared against the discovery results to determine which operating system versions are still supported by the vendors. For example, the assignee of the present invention has done research to determine which HP, Microsoft, MAC, Sun and Unix operating systems are still supported by these vendors. Those supported versions are included in an overlay data file which is used in the collection servers to compare against the discovery results from the level 1 scan to determine which operating systems in a data center are still supported by their vendors and which are not.

In some embodiments, the overlay file also includes information regarding known security vulnerabilities that the manufacturer of an operating system is aware of. This security vulnerability information is organized by version number or service pack number for each operating system. The collection server uses its protocols in the level one scan to determine the type of operating system and vendor is on each machine in the network of interest and to determine which version or service pack level each operating system is. This information is then compared against the data in the overlay file to determine what if any security vulnerabilities each machine on the network of interest has. This information would be important to the insurance company if the policy they are contemplating issuing covers lost data or down time or compromised data because of a security lapse. A policy might also be sought to cover lost profits from sales that could not be fulfilled because the servers were down because of a security breach.

Dependencies are also of interest to insurance companies. Dependencies are relationships between applications and operating system versions where the vendor of the operating system no longer supports the OS version. For example, suppose a server is running Oracle database software on HP UX 10.2 Oracle says that its database software not be run on HP UX 10.2 because that OS version is not supported by Hewlett Packard any longer. Oracle recommends that its database software be run on HP UX 11.0 or higher. This is an example of a dependency. Dependency information is also recorded in the overlay file in some embodiments so that the existence of dependencies can be determined by the insurance company and/or the enterprise IT department.

The information gathered by the level 1 scan can include detection of the existence of at least some application programs. For example, Oracle application mans a particular port number which can be queried by one of the level 1 protocols. If a response of the expected type is received, it is safe to say that Oracle software is installed on the computer. Likewise, other software applications also man particular port numbers which can be queried by TCP/IP packets addressed to those ports and generated by a level one protocol. While not all applications can be discovered in this way, at least some can.

The remaining application programs installed on computers on the network of interest can be determined when a level 2 scan is carried out.

Step 72 represents the start of the level 2 scan process. During this step there are established login IDs and passwords or other credentials needed to log into the computers on the network for which more detailed information is desired. If existing login IDs and passwords exist which the insurance company can be given permission to use, that too can suffice to practice this step of the method. These credentials are established manually in the preferred embodiment, but in some embodiments, may be established by the collection servers in an automated process.

Step 74 represents running one or more level 2 scans. Level 2 scans are necessary to achieve an accurate count of computers and other network devices coupled to the network, because level 1 scans only determine the number of IP addresses on the network which are active. If a computer has both a wireless network connection and an Ethernet connection, it will have two IP addresses but still be only one computer.

To accomplish the level 2 scan, the login ID and password or other credentials are used by the collection servers in step 74 to log onto each machine and run protocols to make function calls to application programmatic interfaces in each operating system. These function calls return information from the operating system such as: which application programs are installed and their version numbers; how many CPUs are in the server; how much memory the server has; what the serial number of the server is; if there is any directly attached storage devices; if there are other peripherals coupled to the server, etc.

Step 76 represents the process of analyzing the results of the level 2 discovery and generate a report or a filtered view of the collected data. The report may be printed and hand delivered to the insurance company or it may be sent electronically over the internet from the collection servers to the insurance company servers.

In some embodiments, enterprise standards overlays may be used to compare the results of level 1 and level 2 scans against to measure progress in implementing plans developed by the IT department. For example, suppose the IT department is running several servers with operating systems which are no longer supported by the vendors. The IT department is aware of this but continues to run these older OS′ because there are a number of legacy software applications all of which would not run on a newer OS and which would have to be upgraded. Suppose the insurance company is requiring the enterprise to migrate to operating systems and applications that are still supported by the vendors.

Some information an insurance company may want to know may not be collectible automatically and may need to be gathered manually. For example, if an insurer is being asked to cover earthquake risks, the insurer may wish to know how far the data center is from the nearest earthquake fault. This information will have to be gathered manually and added to the report, and this step is represented by step 78.

Step 80 represents the process of writing the insurance policy after all the data is collected. The policy may also set as a condition the frequency with which updates on the collected information must be supplied to the insurance company. Since the data is collected almost completely automatically, refreshing the data is not a big problem for the IT department of the customer.

The Collection Servers

In the preferred embodiment, the collection servers 46 and 48 in FIG. 1 run BDNA software from BDNA Corporation in Mountain View, Calif. This software includes the scripts and functionality to run level 1 scans to determine what types of operating systems are present and run level 2 and level 3 scans to gather more information. Level 3 scans involve gathering credentials to login and give a password to each application program that requires user authentication and gather data from the application program by making function calls to the APIs of the application.

The different types of programs that can be used to control the collection servers 46 and 48 to gather data about the assets in a data center define a genus. A system within the genus of the collection server program provides method and apparatus to collect information of different types that characterize a business entity and consolidate all these different types of information about the hardware, software and financial aspects of the entity in a single logical data store (part of collection servers 46 and 48). The data store and the data collection system will have three characteristics that allow the overall system to scale well among the plethora of disparate data sources.

The first of these characteristics that all species of collection server programs within the genus will share is a common way to describe all information as element/attributes data structures. Specifically, the generic way to describe all information creates a different element/attribute data structure for each different type of information, e.g., server, software application program, software license. Each element in an element/attribute data structure contains a definition of the data type and length of a field to be filled in with the name of the asset to which the element corresponds. Each element/attribute data structure has one or more definitions of attributes peculiar to that type element. These definitions include the semantics for what the attribute is and the type and length of data that can fill in the attribute field. For example, a server element will have attributes such as the CPU server type, CPU speed, memory size, files present in the mounted file system, file system mounted, etc. The definitions of each of these attributes includes a definition of what the attribute means about the element (the semantics) and rules regarding what type of data (floating point, integer, string, etc.) that can fill in the attribute field and how long the field is. Thus, all attribute instances of the same type of a particular element that require floating point numbers for their expression will be stored in a common floating point format so programs using that attribute instance data can be simpler in not having to deal with variations in expression of the data of the same attribute. In some embodiments, all attribute data that needs to be expressed as a floating point number is expressed in the same format.

The collection server program does not force all data sources to conform to it. Whatever format the data source provides the attribute data in, that data will be post processed to conform its expression in the collected data store to the definition for that attribute in the element/attribute data structure in terms of data type, data field length and units of measure.

A license type element will have attributes such as the license term in years or months, whether the license is worldwide or for a lesser territory, price, etc.

The second characteristic that all species within the genus will share is provision of a generic way to retrieve attribute data regardless of the element and the type of attribute to be received. This is done by including in each attribute definition in an element/attribute data structure a pointer to one or more “collection instructions” referred to above as scripts. In some embodiments, the collection instruction for each attribute type is included in the attribute definition itself. These “collection instructions” detail how to collect an instance of that particular attribute from a particular data source such as a particular server type, a particular operating system, a particular individual (some collection instructions specify sending e-mail messages to particular individuals requesting a reply including specified information).

More specifically, each attribute of each element, regardless of whether the element is a server, a lease, a maintenance agreement, etc., has a set of collection instructions. These collection instructions control data collector servers such as 46 and 48 to carry out whatever steps are necessary to collect an attribute of that type from whatever data source needs to be contacted to collect the data. The collection instructions also may access a collection adapter which is a code library used by the collector to access data using a specific access protocol.

The definition of each attribute in the element/attributes data structure may include a pointer to a “collection instruction”. The collection instruction is a detailed list of instructions that is specific to the data source and access protocol from which the attribute data is to be received and defines the sequence of steps and protocols that must be taken to retrieve the data of this particular attribute. Each time this “collection instruction” is executed, an instance of that attribute will be retrieved and stored in the collection data store. This instance will be post-processed to put the data into the predefined format for this attribute and stored in the collected data structure in a common data store at a location therein which is designated to store instance of this particular attribute. Sometimes the collected attribute data is stored in the collection servers 46 and 48, and sometimes it is transmitted to an insurance company server for storage via data paths 50 and 52.

As an example of a collection instruction, suppose CPU speed on a UNIX server element is the desired attribute to collect. For UNIX servers, there is a known instruction that can be given to cause the server's operating system to retrieve the CPU speed. Therefore the “collection instruction” to collect the CPU speed for a UNIX server type element, 32 in FIG. 1 for example, will be a logical description or computer program that controls the collection server 46 to, across a protocol described by the collection instructions, give the UNIX server 32 the predetermined instructions or invoke the appropriate function call of an application programmatic interface provided by UNIX servers of this type to request the server to report its CPU speed. The reported CPU speed would be received at the collection server 46 and stored in the collected data table (or sent to the insurance company server for storage).

Another example of a “collection instruction” on how to collect data for a particular type of attribute would be as follows. Suppose the attribute data needed for some reason was the name of the database administrator for an Oracle database. The “collection instruction” for collection of this attribute would be a program that controls the collection gateway to send an email message addressed to a particular person asking that person to send a reply email giving the name of the Oracle database administrator. The program would then scan returning emails for a reply from this person and extract the name of the database administrator from the email and put it in the collected data table. Typically, the email would have a fixed format known to the definition program such that the definition program would know exactly where in the email reply the Oracle database administrator's name would appear. A “collection instruction” to extract the maintenance costs attribute of a software license type element typically would be a definition or code that controls the data collector program to access a particular license file, read the file looking for a particular field or alphanumeric string with a semantic definition indicating it was the maintenance cost and extract the maintenance cost and put that data into the data store.

The third characteristic that all species within the genus of the collection server program share is that information of all different types collected by the agent programs using the definitions is stored in a single common physical data store after post processing to conform the data of each attribute to the data type and field length in the attribute definition for that attribute of that element/attribute data structure. The element/attribute descriptions, containment or system-subsystem relationships between different element/attributes and collected data all are stored in one or more unique data structures in a common data store. By post processing to insure that all attribute data is conformed to the data type and field length in the element/attribute definition, correlations between data of different types is made possible since the format of data of each type is known and can be dealt with regardless of the source from which the data was collected. In other words, by using a generic element/attribute defined structure for every type element and attribute, all the data collected can be represented in a uniform way, and programs to do cross-correlations or mathematical combinations of data of different types or comparisons or side-by-side views or graphs between different data types can be more easily written without having to deal with the complexity of having to be able to handle data of many different types, field lengths but with the same semantics from different sources. These characteristics of the data structures allow data of different types selected by a user to be viewed and/or graphed or mathematically combined or manipulated in some user defined manner. This allows the relationships between the different data types over time to be observed for management analysis. In some embodiments, the user specifications as to how to combine or mathematically manipulate the data are checked to make sure they make sense. That is a user will not be allowed to divide a server name by a CPU speed since that makes no sense, but she would be allowed to divide a server utilization attribute expressed as an integer by a dollar cost for maintenance expressed as a floating point number.

The descriptions of the type and length of data fields defining the element/attribute relationships are stored, in the preferred embodiment, in three logical tables. One table stores the element descriptions, another table stores the descriptions of the type and length of each attribute data field, and a third table stores the mapping between each element and the attributes which define its identity in a “fingerprint”. All complex systems have systems and subsystems within the system. These “containment” relationships are defined in another table data structure. Once all the attribute data is collected for all the elements using the “collection instructions” and data collector, the data for all element types is stored in a one or more “collected data” tables in the common data store after being post processed to make any conversions necessary to convert the collected data to the data type and length format specified in the attribute definition. These “collected data” tables have columns for each attribute type, each column accepting only attribute data instances of the correct data types and field lengths defined in the element/attribute definition data structure and having the proper semantics. In other words, column 1 of the collected data table may be defined as storage for numbers such as 5 digit integers representing CPU speed in units of megahertz for a particular server element reported back by the operating system of that server element, and column two might be assigned to store only strings such as the server's vendor name. Each row of the table will store a single attribute instance data value.

An attribute data instance stored in the collected data table is a sample of the attributes value at a particular point in time. In the preferred embodiment, each entry in the data table for an attribute has a timestamp on it. The timestamp indicates either when the attribute data was collected or at least the sequence in which the attribute data was collected relative to when attribute data for other elements or attribute data for this element was previously created. There is typically a refresh schedule in the preferred species which causes the value of some or all of the attributes to be collected at intervals specified in the refresh schedule. Each element can have its own refresh interval so that rapidly changing elements can have their attribute data collected more frequently than other elements. Thus, changes over time of the value of every attribute can be observed at a configurable interval.

In addition to the refresh interval, data collection follows collection calendars. One or more collection calendars can be used to control at which time, day, and date data collection is to take place. Data collection may also take place as the results of user activity.

In the preferred embodiment, this data store can be searched simultaneously and displayed in a view or graph defined by the user to observe relationships between the different pieces of data over time. This is done using a “correlation index” which is a specification established by the user as to which attribute data to retrieve from the collected data table and how to display it or graph it. The data selected from the collected data tables is typically stored in locations in a correlation table data structure at locations specified in the “correlation index”.

This use of a common data store allows easy integration of all data into reports and provides easy access for purposes of cross referencing certain types of data against other types of data.

A “collection instruction” is a program, script, or list of instructions to be followed by an agent computer called a “data collector” to gather attribute data of a specific attribute for a specific element (asset) or gather attribute data associated with a group of element attributes. For example, if the type of an unknown operating system on a particular computer on the network is to be determined, the “collection instruction” will, in one embodiment, tell the collection gateway to send a particular type or types of network packets that has an undefined type of response packet. This will cause whatever operating system is installed to respond in its own unique way. Fingerprints for all the known or detectable operating systems can then be used to examine the response packet and determine which type of operating system is installed. Another example of a “collection instruction” is as follows. Once the operating system has been determined, it is known what type of queries to make to that operating system over which protocols to determine various things such as: what type of computer it is running on; what file system is mounted; how to determine which processes (computer programs in execution) are running; what chip set the computer uses; which network cards are installed; and which files are present in the file system. A “collection instruction” to find out, for example, which processes are actually in execution at a particular time would instruct the agent to send a message through the network to the operating system to invoke a particular function call of an application programmatic interface which the operating system provides to report back information of the type needed. That message will make the function call and pass the operating system any information it needs in conjunction with that function call. The operating system will respond with information detailing which processes are currently running as listed on its task list etc.

A “fingerprint” is a definition of the partial or complete identity of an asset by a list of the attributes that the asset can have. The list of attributes the asset will have is a “definition” and each attribute either contains a link to a “collection instruction” that controls a data collector to obtain that attribute data for that element or directly includes the “collection instruction” itself. Hereafter, the “definition” will be assumed to contain for each attribute a pointer to the “collection instruction” to gather that attribute data. For example, if a particular application program or suite of programs is installed on a computer such as the Oracle Business Intelligence suite of e-business applications, certain files will be present in the directory structure. The fingerprint for this version of the Oracle Business Intelligence suite of e-business applications will, in its included definition, indicate the names of these files and perhaps other information about them. The fingerprint's definition will be used to access the appropriate collection instructions and gather all the attribute data. That attribute data will then be post processed by a data collector process to format the collected data into the element/attribute format for each attribute of each element defined in data structure #1. Then the properly formatted data is stored in the collected data store defined by data structure #4 which is part of the common data store. Further processing is performed on the collected data to determine if the attributes of an element are present. If they are sufficiently present, then the computer will be determined to have the Oracle Business Intelligence suite of e-business applications element installed. In reality, this suite of applications would probably be broken up into multiple elements, each having a definition defining which files and/or other system information need to be present for that element to be present.

Fingerprints are used to collect all types of information about a company and identify which assets the company has from the collected information. In one sense, a fingerprint is a filter to look at a collected data set and determine which assets the company has from that data. Almost anything that leaves a mark on an organization can be “fingerprinted”. Thus, a fingerprint may have attribute definitions that link to collection instructions that are designed to determine how many hours each day each employee in each different group within the company is working. These collection instructions would typically send e-mails to supervisors in each group or to the employees themselves asking them to send back reply e-mails reporting their workload.

A fingerprint must exist for every operating system, application program, type of computer, lease, license or other type of financial data or any other element that the system will be able to automatically recognize as present in the business organization.

One system within the genus of the collection server program will first collect all the information regarding computers, operating systems that are installed on all the networks of an entity and all the files that exist in the file systems of the operating systems and all the financial information. This information is gathered automatically using protocols, utilities, or API's available on a server executing the instructions of “definitions” on how to collect each type of data to be collected. The collected attribute data is stored in a data structure, and the attribute data is then compared to “fingerprints” which identify each type of asset by its attributes. A determination is then made based upon these comparisons as to which types of assets exist in the organization.

Another system within the genus of the collection server program will iteratively go through each fingerprint and determine which attributes (such as particular file names) have to be present for the asset of each fingerprint to be deemed to be present and then collect just that attribute data and compare it to the fingerprints to determine which assets are present. Specifically, the system will decompose each fingerprint to determine which attributes are defined by the fingerprint as being present if the element type corresponding to the fingerprint is present. Once the list of attributes that needs to be collected for each element type is known, the system will use the appropriate definitions for these attributes and go out and collect the data per the instructions in the definitions. The attribute data so collected will be stored in the data store and compared to the fingerprints. If sufficient attributes of a particular element type fingerprint are found to be present, then the system determines that the element type defined by that fingerprint is present and lists the asset in a catalog database.

Although the collection server program has been disclosed in terms of the preferred and alternative embodiments disclosed herein, those skilled in the art will appreciate that modifications and improvements may be made without departing from the scope of the collection server program. All such modifications are intended to be included within the scope of the claims appended hereto.

What is claimed is:

1. A process for gathering data automatically about assets to be insured, comprising the steps:
A) receiving a request to write an insurance policy on some aspect of a data center;
B) identifying the scope of risks to be covered by said insurance policy;
C) installing one or more collection servers on each of said one or more networks in said one or more data centers to be covered by said insurance policy, or installing collection server software on one or more servers already coupled to said one or more networks in said one or more data centers to be covered by said insurance policy;
D) obtaining and programming into said one or more collection servers one or more Internet Protocol (IP) address ranges for one or more networks in one or more data centers to be covered by said insurance policy;
E) run a level 1 scan by executing software on said one more collection servers one or more times to collect data from devices coupled to said one or more networks in said one or more data centers covered by said insurance policy;
F) analyzing the discovered results from said one or more level 1 scans to determine whatever desired information can be determined from said level 1 results and determining if more information is desired about a machine at any particular IP address according to the needs of said insurance company;
G) establishing login IDs and passwords or other credentials for any machines for which more information is desired or obtaining permission to use any login IDs and passwords or other credentials that already exist for machines for which more information is desired;
H) using said login IDs and passwords or other credentials, logging into any machines about which further information is desired and invoking function calls of application programmatic interfaces of operating systems on said machines to solicit more detailed information about said machines;
I) analyzing information gathered during said level 2 scans and sending data to insurance company for evaluation.

2. The process of claim 2 wherein step A comprises receiving a request to write an insurance policy on one or more aspects of a data center operation.

3. The process of claim 1 wherein step E comprises:
sending ping command packets to all said IP addresses in said address range entered in step D;
determining from responses to said ping packets which IP addresses have active and responding devices associated therewith;
using a plurality of different protocols, sending packets according to each protocol to each active IP address and waiting for response packets;
if any response packets arrive, attempting to interpret said response packets according to said different protocols;
if a response packet from a particular machine makes sense to one of said protocols, making a determination that said machine understands said protocol and sending query packets to invoke function calls of an application programmatic interface of said protocol to solicit information about said machine.

4. The process of claim 3 wherein said different protocols include SNMP, FTP, HTTP, SMTP, NMAP and/or other protocols.

5. The process of claim 1 further comprising the steps:
J) generating reports on said collected level 1 and level 2 scan data;
K) sending said reports to said insurance company.

6. The process of claim 1 further comprising the steps of manually analyzing data gathered by said level 1 and level 2 scans and generating reports based upon said manual analysis of data and forwarding said reports to said insurance company.

7. The process of claim 1 further comprising the steps of manually gathering information about various assets and adding said information to any report generated for transmission to said insurance company.

8. A computer comprising:
a display;
a data entry device;
a central processing unit programmed with an operating system and further programmed with one or more application programs that control said central processing unit to perform the following process:
A) receiving a request to write an insurance policy on some aspect of a data center;
B) identifying the scope of risks to be covered by said insurance policy;
C) installing one or more collection servers on each of said one or more networks in said one or more data centers to be covered by said insurance policy, or installing collection server software on one or more servers already coupled to said one or more networks in said one or more data centers to be covered by said insurance policy;
D) obtaining and programming into said one or more collection servers one or more Internet Protocol (IP) address ranges for one or more networks in one or more data centers to be covered by said insurance policy;
E) run a level 1 scan by executing software on said one more collection servers one or more times to collect data from devices coupled to said one or more networks in said one or more data centers covered by said insurance policy;
F) analyzing the discovered results from said one or more level 1 scans to determine whatever desired information can be determined from said level 1 results and determining if more information is desired about a machine at any particular IP address according to the needs of said insurance company;
G) establishing login IDs and passwords or other credentials for any machines for which more information is desired or obtaining permission to use any login IDs and passwords or other credentials that already exist for machines for which more information is desired;
H) using said login IDs and passwords or other credentials, logging into any machines about which further information is desired and invoking function calls of application programmatic interfaces of operating systems on said machines to solicit more detailed information about said machines;
I) analyzing information gathered during said level 2 scans and sending data to insurance company for evaluation.

9. The process of claim 8 wherein said central processing unit is further programmed to perform the following process steps to perform step E:
sending ping command packets to all said IP addresses in said address range entered in step D;
determining from responses to said ping packets which IP addresses have active and responding devices associated therewith;
using a plurality of different protocols, sending packets according to each protocol to each active IP address and waiting for response packets;
if any response packets arrive, attempting to interpret said response packets according to said different protocols;
if a response packet from a particular machine makes sense to one of said protocols, making a determination that said machine understands said protocol and sending query packets to invoke function calls of an application programmatic interface of said protocol to solicit information about said machine.

10. A computer readable medium having stored thereon computer-readable instructions which, when executed by a computer, cause said computer to perform the following process:
A) receiving a request to write an insurance policy on some aspect of a data center;
B) identifying the scope of risks to be covered by said insurance policy;
C) installing one or more collection servers on each of said one or more networks in said one or more data centers to be covered by said insurance policy, or installing collection server software on one or more servers already coupled to said one or more networks in said one or more data centers to be covered by said insurance policy;
D) obtaining and programming into said one or more collection servers one or more Internet Protocol (IP) address ranges for one or more networks in one or more data centers to be covered by said insurance policy;
E) run a level 1 scan by executing software on said one more collection servers one or more times to collect data from devices coupled to said one or more networks in said one or more data centers covered by said insurance policy;
F) analyzing the discovered results from said one or more level 1 scans to determine whatever desired information can be determined from said level 1 results and determining if more information is desired about a machine at any particular IP address according to the needs of said insurance company;
G) establishing login IDs and passwords or other credentials for any machines for which more information is desired or obtaining permission to use any login IDs and passwords or other credentials that already exist for machines for which more information is desired;
H) using said login IDs and passwords or other credentials, logging into any machines about which further information is desired and invoking function calls of application programmatic interfaces of operating systems on said machines to solicit more detailed information about said machines;
I) analyzing information gathered during said level 2 scans and sending data to insurance company for evaluation.

11. The computer readable medium of claim 10 further storing computer readable instructions which when executed by a computer control said computer to execute step E by performing the following steps:
sending ping command packets to all said IP addresses in said address range entered in step D;
determining from responses to said ping packets which IP addresses have active and responding devices associated therewith;
using a plurality of different protocols, sending packets according to each protocol to each active IP address and waiting for response packets;
if any response packets arrive, attempting to interpret said response packets according to said different protocols;
if a response packet from a particular machine makes sense to one of said protocols, making a determination that said machine understands said protocol and sending query packets to invoke function calls of an application programmatic interface of said protocol to solicit information about said machine.
